(19) United States
(12) Patent Application Publication
(10) Pub. No.: US 2024/0410165 A1
(43) Pub. Date: Dec. 12, 2024

(54) Sound Reducing Enclosure and Enclosure Wall with Integral Tunable Resonator for Manufacturing Environment

(71) Applicant: The Boeing Company, Arlington, VA (US)

(72) Inventors: Naval Kishore Agarwal, Sammamish, WA (US); Steven F. Griffin, Kihei, HI (US)

(21) Appl. No.: 18/810,741

(22) Filed: Aug. 21, 2024

Related U.S. Application Data
(63) Continuation of application No. 17/585,805, filed on Jan. 27, 2022.
(60) Provisional application No. 63/167,295, filed on Mar. 29, 2021.

(51) Int. Cl. E04B 1/84; G10K 11/172; G10K 11/178

(52) U.S. Cl. CPC E04B 1/84; G10K 11/172; G10K 11/17823; G10K 11/17854; E04B 2001/8485

(57) ABSTRACT

Methods, systems, and apparatuses are disclosed for reducing sound level, by providing enclosures comprising enclosure walls having integral tunable resonator cavities, and reducing sound levels within the enclosure in response to detected sound levels outside of the enclosure.

### RELATED APPLICATIONS

This application is a continuation of U.S. Ser. No. 17/585,805 filed Jan. 27, 2022, which claims priority to U.S. Provisional Patent Application Ser. No. 63/167,295 filed on Mar. 29, 2021, the entire contents of both of which are incorporated herein by reference.

### TECHNOLOGICAL FIELD

The present disclosure relates generally to the field of sound decibel reduction as it relates to workplace safety. More specifically the present disclosure relates to the field of sound suppression in environments housing personnel located proximate to loud environments, including, for example, shop floor environments.

### BACKGROUND

Workers and personnel occupying buildings that house large manufacturing operations, including automated operations, are typically exposed to a significant level of noise. When operational noise levels, especially operational noise levels within an enclosed building, reach and are maintained at high enough levels, for prolonged duration (e.g., an eight our work shift, etc.) personnel exposed to the noise levels can experience long term effects that can include short-term and even long-term damage including hearing impairment, hearing loss, etc. Unless explicitly identified as such, no statement herein is admitted as prior art merely by its inclusion in the Technological Field and/or Background section.

### SUMMARY

Presents aspects disclose customized kiosks or enclosures that can include wall segments that incorporate sound-reducing members that can be tailored to reduce ambient sound decibel levels within the enclosures. The enclosures can be fashioned, for example, into useful workstations, operational control centers, offices, breakrooms, etc., with the enclosures located proximate to and/or exposed to noise-generating operations at regions of, for example, a factory or shop floor. According to present aspects, occupants within the enclosures can experience a significant reduction in ambient sound decibel levels as compared to the decibel levels outside of the enclosures, as present apparatuses, systems, and methods can automatically condition and otherwise tailor, in real time, the sound levels admitted into the enclosure. The terms “decibel level” and “decibel value” or decibel level value” are equivalent terms and are used interchangeably.

According to present aspects, a method is disclosed for reducing the decibel level of sound within an enclosure, with the method including providing an enclosure, and with the enclosure comprising a plurality of enclosure wall sections. The plurality of enclosure wall sections can be in communication with a floor that can be an enclosure floor, and with at least one of the plurality of wall sections further comprising at least one resonator cavity. The at least one resonator cavity can include a first resonator cavity volume, with the at least one resonator cavity in communication with an actuator, and with the actuator further in communication with a drive mechanism. The at least one resonator cavity further includes at least one resonator cavity fixed wall, and at least one resonator cavity moveable wall, with the at least one resonator cavity moveable wall in communication with the actuator and the drive mechanism. The resonator cavity further includes a resonator cavity neck. The method further includes providing a sound detector, with at least a portion of the sound detector exposed to an area that is exterior to the enclosure, with the sound detector configured to detect a first sound level exterior to the enclosure, and with the first sound level having a first decibel value. The sound detector can be positioned exterior to the enclosure or can be integrated within the disclosure. The method further includes providing a controller, with the controller in communication with the sound detector, and with the controller further in communication with the at least one resonator cavity moveable wall. The method further includes detecting the first sound level, with the first sound level detected exterior to the enclosure, sending a signal from the sound detector to the controller, sending a signal from the controller to the actuator, actuating the drive mechanism, and moving the at least one resonator cavity moveable wall. The method further includes altering the first resonator cavity volume to a second resonator cavity volume in response to the first sound level detected exterior to the enclosure, and producing a second sound level within the enclosure, with the second sound level having a second decibel value, and with the second decibel value less than the first decibel value.

In another aspect the second sound level represents a reduction in decibel value from the first decibel value by an amount ranging from about a 20 to about a 25 decibel value reduction.

In another aspect, the resonator cavity neck comprises the at least one resonator cavity moveable wall.

In a further aspect, the method further comprises altering the first resonator cavity volume to a second resonator cavity volume in real time in response to the first sound level detected exterior to the enclosure.

In another aspect at least one of the plurality of enclosure wall sections comprises an at least two-part enclosure wall section, with the at least two-part enclosure wall section including an enclosure wall first section and an enclosure wall second section.

In another aspect, one of the enclosure wall first section and the enclosure wall second section is a fixed wall section.

In a further aspect, at least one of the enclosure wall first section and the enclosure wall second section comprises a moveable wall section, with the moveable wall section in communication with the drive mechanism.

In another aspect, the method further includes orienting the enclosure wall first section and the enclosure wall second section relative to one another to form the at least two-part enclosure wall section, forming at least one resonator cavity in the at least two-part enclosure wall section, said at least one resonator cavity oriented between the enclosure wall first section and the enclosure wall second section, actuating the drive mechanism, moving laterally at least a portion of at least one of the enclosure wall first section and the enclosure wall second section relative to one another, and altering the dimension of the at least one resonator cavity.

In another aspect, the at least one resonator cavity comprises a resonator neck. In a further aspect, the resonator neck comprises a pathway from the at least one resonator cavity through the enclosure wall first section to an exterior environment.

In another aspect, the enclosure wall first section comprises at least one moveable wall section, said at least one moveable wall section in communication with the drive mechanism.

In another aspect, the enclosure wall first section comprises at least one moveable wall section, said at least one moveable wall section in communication with the drive mechanism.

In a further aspect, the enclosure wall first section comprises a plurality of moveable wall sections, said plurality of moveable wall sections in communication with at least one drive mechanism.

In another aspect, the enclosure wall first section comprises a plurality of moveable wall sections, each of said plurality of moveable wall sections in communication with a separate drive mechanism (e.g., an individual drive mechanism).

In another aspect, a method further includes orienting the enclosure wall first section and the enclosure wall second section relative to one another to form the at least two-part enclosure wall section, forming at least one resonator cavity in the at least two-part enclosure wall section, with the at least one resonator cavity oriented between the enclosure wall first section and the enclosure wall second section, actuating the drive mechanism, moving vertically at least one of the enclosure wall first section and the enclosure wall second section relative to one another, altering the dimension of the at least one resonator cavity.

In another aspect, a method further includes altering the dimension of the resonator cavity neck in real time in response to the first sound level detected exterior to the enclosure.

In a further aspect, a method further includes altering the width of the resonator cavity neck in real time in response to the first sound level detected exterior to the enclosure.

According to further present aspects, an apparatus for reducing the decibel level of sound within an enclosure, with the apparatus including an enclosure, with the enclosure including a plurality of enclosure wall sections, and with the enclosure further including at least one of the plurality of wall sections further including at least one resonator cavity, with the at least one resonator cavity having a first resonator cavity volume, with the at least one resonator cavity in communication with a resonator cavity actuator, and with the resonator cavity actuator further in communication with a resonator cavity drive mechanism. The at least one resonator cavity further includes at least one resonator cavity fixed wall, and at least one resonator cavity moveable wall, with at least one resonator cavity moveable wall in communication with the resonator cavity actuator and the resonator cavity drive mechanism. The at least one resonator cavity further includes a resonator cavity neck. The apparatus further includes a sound detector, with the sound detector positioned to detect sound originating exterior to the enclosure, with the sound detector configured to detect a first sound level exterior to the enclosure, and the first sound level having a first decibel value. The apparatus further includes a controller, with the controller in communication with the sound detector, and with the controller further in communication with at least one of the at least one resonator cavity moveable wall, the resonator cavity actuator, and the resonator cavity drive mechanism.

In another aspect, the enclosure includes an enclosure floor segment, with the enclosure floor segment at least partially bounded by or otherwise in communication with the plurality of enclosure wall sections.

In another aspect, the resonator cavity drive mechanism is configured to drive in real time the at least one resonator cavity moveable wall to alter the first resonator cavity volume of the at least one resonator cavity in response to a detected first sound level.

In another aspect, the resonator cavity at least one resonator cavity moveable wall is driven in real time by the drive mechanism to alter the volume of the at least one resonator cavity in response to a detected first sound level.

In a further aspect, the resonator cavity neck comprises the at least one resonator cavity moveable wall.

In a further aspect, the at least one resonator cavity moveable wall comprises the resonator cavity neck.

In another aspect, at least one of the plurality of enclosure wall sections includes an at least two-part enclosure wall section, said at least two-part enclosure wall section including an enclosure wall first section and an enclosure wall second section.

In another aspect, one of the enclosure wall first section and the enclosure wall second section comprises a fixed wall section.

In a further aspect, at least one of the enclosure wall first section and the enclosure wall second section comprises at least one moveable wall section, said at least one moveable wall section in communication with the resonator cavity drive mechanism.

In another aspect, the enclosure wall first section and the enclosure wall second section are oriented relative to one another to form the at least two-part enclosure wall section, with the at least two-part enclosure wall section configured to form at least one resonator cavity between the enclosure wall first section and the enclosure wall second section, and with the at least one of the enclosure wall first section and the enclosure wall second section configured to move laterally relative to one another to alter at least one of the dimension of the at least one resonator cavity and the volume of the at least one resonator cavity.

In another aspect, the enclosure wall first section and the enclosure wall second section are oriented relative to one another to form the at least two-part enclosure wall section, with the at least two-part enclosure wall section configured to form at least one resonator cavity between the enclosure wall first section and the enclosure wall second section, and with the at least one of the enclosure wall first section and the enclosure wall second section is configured to move laterally relative to one another to alter at the resonator cavity first volume to a resonator cavity second volume, said resonator cavity second volume differing from the resonator cavity first volume.

In another aspect, the enclosure wall first section and the enclosure wall second section are oriented relative to one another to form the at least two-part enclosure wall section, with the at least two-part enclosure wall section configured to form at least one resonator cavity between the enclosure wall first section and the enclosure wall second section, and with the at least one of the enclosure wall first section and the enclosure wall second section is configured to move laterally relative to one another to alter at least one of a resonator cavity dimension and a resonator cavity volume configured to move laterally relative to one another to alter volume of the at least one resonator cavity from the first resonator cavity volume.

In another aspect, the at least one resonator cavity includes a resonator neck.

In another aspect, the resonator neck includes a pathway from the at least one resonator cavity through the enclosure wall first section to an exterior environment.

In another aspect, the enclosure wall first section includes at least one moveable wall section, said at least one moveable wall section in communication with the resonator cavity drive mechanism.

In another aspect, the enclosure wall first section includes a plurality of moveable wall sections, said plurality of moveable wall sections in communication with at least one resonator cavity drive mechanism.

In a further aspect, the enclosure wall first section includes a plurality of moveable wall sections, each of said plurality of moveable wall sections in communication with a separate resonator cavity drive mechanism.

In another aspect, the enclosure wall first section and the enclosure wall second section are configured to form the at least two-part enclosure wall section, with the at least two-part enclosure wall section configured to form at least one resonator cavity between the enclosure wall first section and the enclosure wall second section, and with the at least one of the enclosure wall first section and the enclosure wall second section configured to move vertically relative to one another to alter a dimension of the at least one resonator cavity.

In another aspect, the at least one of the enclosure wall first section and the enclosure wall second section are further configured to alter a dimension of the resonator cavity neck.

In a further aspect, the at least one of the enclosure wall first section and the enclosure wall second section are further configured to alter a width of the resonator cavity neck.

According to further present aspects, an enclosure is disclosed, with the enclosure including an enclosure floor, a plurality of enclosure wall sections, with the plurality of enclosure wall sections optionally in communication with the enclosure floor, with at least one of the plurality of wall sections further comprising at least one resonator cavity, with at least one resonator cavity having a first resonator cavity volume. The at least one resonator cavity is in communication with a resonator cavity actuator, with the resonator cavity actuator further in communication with a resonator cavity drive mechanism, and the at least one resonator cavity further includes at least one resonator cavity moveable wall, with the resonator cavity moveable wall in communication with the actuator and the drive mechanism, with the resonator cavity further including a resonator cavity neck.

In another aspect, the at least one resonator cavity is further in communication with at least one resonator cavity fixed wall.

In another aspect, the drive mechanism is configured to drive in real time the at least one resonator cavity moveable wall to alter the volume of the at least one resonator cavity in response to a detected first sound level.

In another aspect, the resonator cavity neck comprises the at least one resonator cavity moveable wall.

In another aspect, at least one of the plurality of enclosure wall sections includes at least a two-part enclosure wall section, with the at least two-part enclosure wall section including an enclosure wall first section, and an enclosure wall second section.

In another aspect, one of the enclosure wall first section and the enclosure wall second section includes a fixed wall section.

In another aspect, at least one of the enclosure wall first section and the enclosure wall second section includes a moveable wall section, with the moveable wall section in communication with the drive mechanism.

In another aspect, the enclosure wall first section and the enclosure wall second section are oriented relative to one another to form the at least two-part enclosure wall section. The at least two-part enclosure wall section is configured to form at least one resonator cavity between the enclosure wall first section and the enclosure wall second section and the at least one of the enclosure wall first section and the enclosure wall second section are configured to move laterally relative to one another to alter the dimension of the at least one resonator cavity. In another aspect, the at least one resonator cavity comprises a resonator neck.

In a further aspect, the resonator neck comprises a pathway from the at least one resonator cavity through the enclosure wall first section to an exterior environment.

In a further aspect, the enclosure wall first section comprises at least one moveable wall section, with the at least one moveable wall section in communication with the drive mechanism.

In another aspect, the enclosure wall first section comprises a plurality of moveable wall sections, said plurality of moveable wall sections in communication with the drive mechanism.

In another aspect, the enclosure wall first section comprises a plurality of moveable wall sections, with each of said plurality of moveable wall sections in communication with a separate drive mechanism.

In another aspect, the enclosure wall first section and the enclosure wall second section are configured to form the at least two-part enclosure wall section, the at least two-part enclosure wall section is configured to form at least one resonator cavity between the enclosure wall first section and the enclosure wall second section, and the at least one of the enclosure wall first section and the enclosure wall second section are configured to move vertically relative to one another to alter a resonator cavity dimension of the at least one resonator cavity. In another aspect, the at least one of the enclosure wall first section and the enclosure wall second section are further configured to alter a dimension of the resonator cavity neck.

In another aspect, the at least one of the enclosure wall first section and the enclosure wall second section are further configured to alter a width of the resonator cavity neck.

According to further present aspects, an enclosure wall is disclosed, with the enclosure wall including a first wall side, a second wall side, and a wall interior thickness, with the wall interior thickness bounded by the first wall side and the second wall side. The wall interior thickness further includes at least one resonator cavity having a first resonator cavity volume, with the at least one resonator cavity in communication with a resonator cavity actuator, with the resonator cavity actuator further in communication with a resonator cavity drive mechanism. The at least one resonator cavity further includes at least one resonator cavity fixed wall, at least one resonator cavity moveable wall, with the at least one resonator cavity moveable wall in communication with at least one of the resonator cavity actuator and the resonator cavity drive mechanism. The interior wall thickness further includes a resonator cavity neck.

In another aspect, the enclosure wall includes at least one integral tunable resonator.

In another aspect, the drive mechanism is configured to drive in real time the at least one resonator cavity moveable wall to alter the first resonator volume of the at least one resonator cavity in response to a detected first sound level.

According to a further present aspect, an enclosure wall is disclosed including at least a two-part enclosure wall section, with the at least two-part enclosure wall section including an enclosure wall first section, and an enclosure wall second section. The enclosure wall first section and the enclosure wall second section are oriented relative to one another to form the at least two-part enclosure wall section, and the at least two-part enclosure wall section is configured to form at least one resonator cavity between the enclosure wall first section and the enclosure wall second section.

In another aspect, the at least one resonator cavity comprises a resonator cavity first volume.

In another aspect, the at least one of the enclosure wall first section and the enclosure wall second section are configured to move laterally relative to one another to alter the dimension of the at least one resonator cavity.

In another aspect, the at least one of the enclosure wall first section and the enclosure wall second section are configured to move laterally relative to one another to alter the resonator cavity first volume, including altering the resonator cavity first volume to a resonator cavity second volume.

In another aspect, one of the enclosure wall first section and the enclosure wall second section includes a fixed wall section.

In another aspect, at least one of the enclosure wall first section and the enclosure wall second section includes a moveable wall section, with the moveable wall section in communication with a drive mechanism.

In another aspect, the at least one resonator cavity comprises a resonator neck.

In a further aspect, the resonator neck comprises a pathway from the at least one resonator cavity through the enclosure wall first section to an exterior environment.

In another aspect, the enclosure wall first section includes at least one moveable wall section.

In another aspect, the enclosure wall first section includes a plurality of moveable wall sections.

In another aspect, the enclosure wall first section and the enclosure wall second section are configured to form the at least two-part enclosure wall section, the at least two-part enclosure wall section is configured to form the at least one resonator cavity between the enclosure wall first section and the enclosure wall second section, and the at least one of the enclosure wall first section and the enclosure wall second section are configured to move vertically relative to one another to alter a dimension of the at least one resonator cavity.

In another aspect, the at least one of the enclosure wall first section and the enclosure wall second section are further configured to alter a dimension of the resonator cavity neck.

In a further aspect, the at least one of the enclosure wall first section and the enclosure wall second section are further configured to alter a width of the resonator cavity neck.

In another aspect, the enclosure wall further comprises a first resonator cavity comprising a first resonator cavity neck, with the first resonator cavity neck comprising a first resonator cavity neck width. The enclosure wall further comprises a second resonator cavity comprising a second resonator cavity neck, with second resonator cavity neck comprising a second resonator cavity neck width, and with the second resonator cavity width selected to differ from the first resonator cavity neck width.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

Having thus described variations of the disclosure in general terms, reference will now be made to the accompanying drawings, which are not necessarily drawn to scale, and wherein:

FIG. 1 is a cross-sectional illustration of an enclosure, according to present aspects;

FIG. 2 is an enlarged cross-sectional illustration of a resonator, according to present aspects;

FIG. 3 is a cross-sectional illustration of an enclosure wall, according to present aspects;

FIG. 4 is a cross-sectional illustration of an enclosure wall, according to present aspects;

FIG. 5A is a cross-sectional illustration of an enclosure wall section, according to present aspects;

FIG. 5B is a graph showing a representation of sound frequency tonal peaks and frequency harmonics adjusted, according to present aspects;

FIG. 6A is a graph representing of tonal peaks of ambient noise;

FIG. 6B is a graph representing the reduction of tonal peaks of ambient noise with resonators in an enclosure, according to present aspects;

FIG. 7A is a graph representing of tonal peaks of ambient noise;

FIG. 7B is a graph representing the reduction of tonal peaks of ambient noise with resonators in a partial enclosure, according to present aspects;

FIG. 8 is a flowchart outlining a method according to present aspects;

FIG. 9 is a flowchart outlining a method according to present aspects;

FIG. 10 is a flowchart outlining a method according to present aspects; and

FIG. 11 is a flowchart outlining a method according to present aspects.

### DETAILED DESCRIPTION

Automation has improved manufacturing in the areas of quality and speed, but the resulting high level of noise and vibration continues to affect workers in various manufacturing settings. Noise exposure is one of the most persistent problems for manufacturing personnel, and can result in sustained hearing damage or even permanent hearing loss. In certain manufacturing settings (e.g., areas of the factory shop floor, etc.) repetitive manual and/or robotic noise levels including, for example, riveting noise levels, may be very high, depending on the number of machines, their installation, the factory floor/wall/ceiling size, etc. Despite the adoption of noise abatement treatments, machine noise levels in certain manufacturing areas may persist and approach undesirable levels as set forth by regulatory agencies or internal company safety limits.

Such noise levels can be compounded when multiple machines are operating simultaneously. Prolonged exposure to high noise levels may have adverse impacts on the human hearing system and/or contribute to psychological concerns, job satisfaction, workforce turnover rates, etc.

For example, typical riveting processes used to assemble components, can involve either manual riveting or the use of riveting robots. The manual riveting technique requires a pneumatic hammer in conjunction with a bucking bar. A pneumatic hammer is set at one end of the rivet, while the bucking bar is held at the other end. An automatic riveting machine compresses rivets to join materials together. These operations produce significant noise and can create a hazardous environment for operators and other people in the workshop floor vicinity.

Noise levels in a manufacturing environment (e.g., a work factory shop floor, etc.) can be theoretically reduced to an extent by noise reduction at source, in transmission path, reducing reflections from hard surfaces (e.g., wall, ceiling, floor, etc.), using personal protective equipment, and combinations thereof. However, if the noise levels are very high, (e.g., a noise sound decibel level ranging from about 120 to about 130 dB, or higher), reducing the noise to a level to avoid hearing loss damage injuries has been difficult or impossible to accomplish.

Riveting tools generally operate at a low frequency and create a sharp tone or peak corresponding to riveting frequency in the noise spectrum. These tonal peaks are generally much higher than the broadband part of the spectrum and are major contributors to overall noise levels. Accordingly, according to present aspects, the disclosed apparatuses, systems, and methods condition and tailor sound within an enclosure and further reduce problematic tonal peak(s) that occur in repetitive manufacturing processes, including, for example, manual and automated riveting processes.

According to present aspects, an at least partially or completely enclosed structure that can be, for example, a workstation “kiosk” comprises tunable resonators to at least significantly reduce low-frequency tones caused by, for example, the frequency tones associated with automatic/robotic riveting operation. According to further present aspects, the tunable resonators can be selectively tuned, tailored, etc., to reactively “muffle” selected frequencies (including, e.g., sound emanated during machining operations such as, for example, riveting sound frequencies, etc.) in response to sound detected outside an enclosure in substantially “real-time”.

The present apparatuses and systems comprise an integrated resonator comprising a tunable resonator cavity, with the tunable resonator cavity configured to act, for example, as an acoustical spring, with the cavity working as the mass of the system. Selected resonator cavity dimensions and volumes (including cavity neck dimensions and volumes) are selectively altered and “tuned” by moving resonator cavity structural components to change the resonator cavity volume in response to sensed or detected sound frequencies. According to present aspects, the change in resonator cavity volume, changes the resonator frequency. According to still further aspects, a second reduced sound level achievable by implementing the present apparatuses, systems, and methods achieves a reduction in decibel sound value from, and in response to, an initial, or first, decibel value by a decibel value reduction ranging from about a 20 to about a 25 decibel reduction.

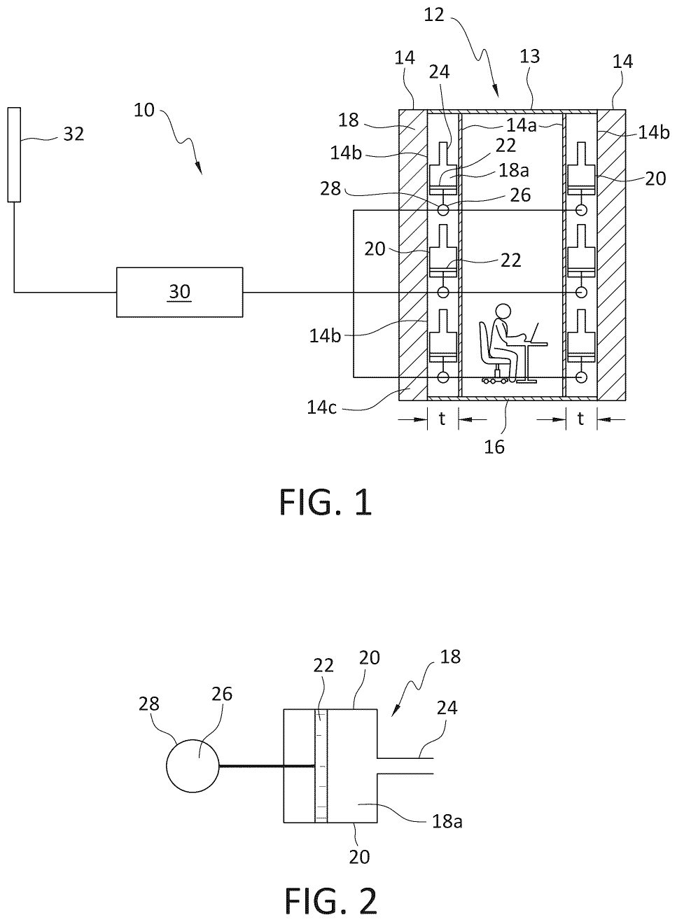

FIG. 1 shows an aspect of the present disclosure where an exemplary apparatus 10 comprises an enclosure 12, with the enclosure 12 shown in cross-section. As shown in FIG. 1, enclosure 12 comprises an enclosure wall 14, with enclosure wall 14 having a wall thickness “t”, and with the enclosure wall 14 comprising an enclosure wall first surface 14a (e.g., an enclosure wall outer surface that is exposed to the exterior of the enclosure) and an enclosure wall second surface 14b (e.g., enclosure wall inner surface that is exposed to the enclosure interior). Enclosure wall 14 can further comprise wall insulation 14c, with the insulation 14c selected to dampen sound, with sound-dampening characteristics of the selected insulation further contributing to present sound-reducing (e.g., sound dampening) aspects of the presently presented enclosures, and according to present aspects.

The enclosure walls 14 are shown in FIG. 1 in communication with a floor 16 and an enclosure ceiling 13. The floor 16 can be component of the enclosure 12, or the floor 16 can be an existing floor onto which the enclosure 12 is placed. Habitable enclosure area 17 within enclosure 12 shows a worker 15 engaged at a workstation within the enclosure 14. FIG. 1 further shows a plurality of resonators 18, with each resonator 18 comprising a resonator cavity 18a, and with the resonator cavity 18a bounded by resonator cavity fixed walls 20 and a resonator cavity moveable wall 22. Resonator 18 further comprises a resonator neck 24, with the area within the resonator neck considered to contribute to a total area of a resonator cavity area. Since the resonator neck bounds a region of the resonator cavity proximate to the resonator neck, the terms “resonator neck” and “resonator cavity neck” are used equivalently and interchangeably herein.

FIG. 1 further shows apparatus 10 comprising a resonator cavity actuator 26 that, as shown in FIG. 1, can be integral with resonator cavity drive mechanism 28, with the resonator cavity drive mechanism 28 in communication with the resonator cavity moveable wall 22. The resonator cavity actuator shown at least in FIGS. 1, 2, 3, and 4 is equivalently referred to herein as a resonator cavity drive mechanism actuator. The resonator cavity actuators 26 and resonator cavity drive mechanisms 28 are shown in FIG. 1 as being in communication with a resonator controller 30 (that can be, for example, a computer controller) that is in communication with the plurality of resonator cavity actuators 26 and resonator cavity drive mechanisms 28, although, further aspects (not shown in FIG. 1) contemplate a plurality of separate controllers each in communication with a separate resonator cavity drive mechanism 28, for example.

FIG. 1 further shows a sound detector 32 (that can be, for example, a microphone, a device configured to detect soundwaves/sound frequencies, etc.) in communication with controller 30. According to present aspects, the controller 30 can receive signal from the sound detector 32, with the controller 30 then able to send signals to be received by the resonator cavity actuators 26, with the resonator cavity actuators 26 then initiating the resonator cavity drive mechanisms 28 to move the resonator cavity moveable wall to a position to alter, “tune”, and otherwise “set” the resonator cavity frequency to a selected frequency detected by the sound detector.

FIG. 2 is an enlarged, at least partial cross-sectional view of the exemplary resonator 18 of the type shown in FIG. 1. As shown in FIG. 2, resonator 18 comprises resonator cavity 18a, and with the resonator cavity 18a bounded by resonator cavity fixed walls 20 and a resonator cavity moveable wall 22. Resonator 18 further comprises a resonator neck 24, with the area within the resonator neck considered to contribute to a total area of a resonator cavity area. FIG. 2 further shows resonator cavity actuator 26 that can be integral with resonator cavity drive mechanism 28, with the resonator cavity drive mechanism 28 in communication with the resonator cavity moveable wall 22.

According to a present aspect, in operation, when the resonator cavity actuator 26 actuates the resonator cavity drive mechanism 28, resonator cavity moveable wall 22 can be moved from an initial or “first” resonator moveable wall position to a second resonator moveable wall position. According to one present aspect, the resonator cavity drive mechanism 28 in combination with the resonator moveable wall 22 can, in “piston-like” fashion move within or otherwise extend into the resonator cavity fixed walls 20 and can reduce the resonator cavity volume. The resonator moveable wall (e.g., “piston”) position that impacts the resonator cavity volume is calibrated against the resonator frequency and is used to determine the second resonator moveable wall position (e.g., the selected “frequency-cancelling” and “tonal peak-reducing” position).

Resonators shown in FIGS. 1 and 2 are equivalently referred to herein as “adjustable sound frequency resonators” with the resonators configured, according to present aspect, to tailor and otherwise adjust sound frequencies by adjusting a resonator cavity volume, in real-time, in response to a detected first sound level outside of the enclosure to achieve a selected and reduced second sound level within the enclosure. According to further present aspects, though not shown, the present enclosures may not include a ceiling. In addition, it is understood that the term “enclosure” as used herein, can include structures thought to be “partial enclosures”, with such partial enclosures comprising fewer than four walls, and with the partial enclosure further not necessarily comprising a ceiling. Again, according to present aspects, the “enclosures” may comprise fewer than four walls, and may further not comprise a ceiling.

As shown in FIG. 1, the enclosure wall 14 is understood to be a fixed wall.

According to apparatus 10 and enclosure 14, the motion required to alter the resonator cavity volume is generated by movement of the resonator movable wall 22 acting like a part of a piston within resonator cavity 18. That is, according to present aspects as shown in FIG. 1, the enclosure wall 14 is said to be a stationary or “fixed” wall that is generally not a moveable wall, and/or an enclosure wall that does not comprises sections of a wall that are moveable.

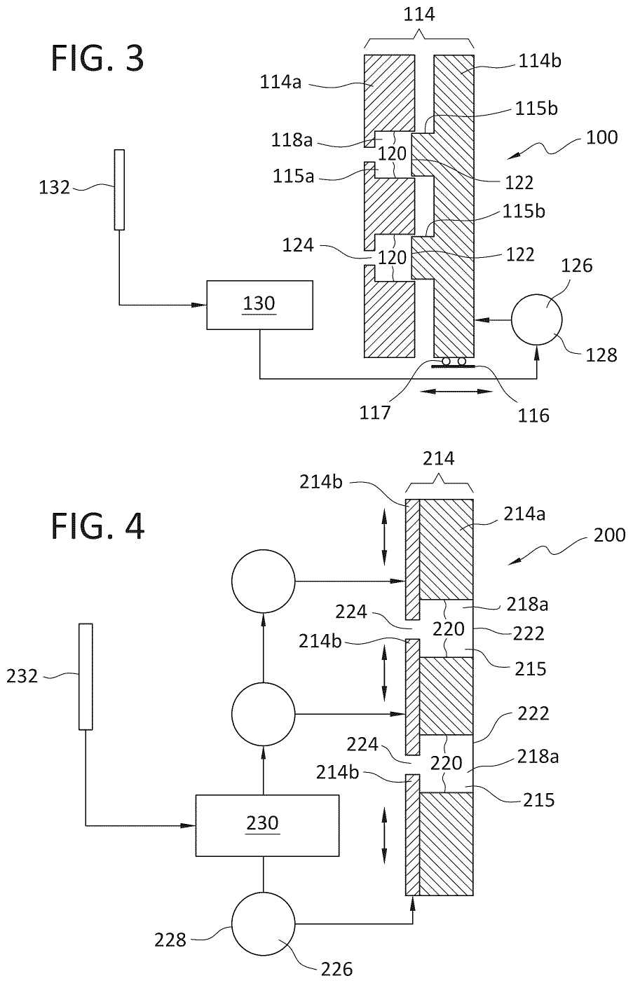

In contrast to FIG. 1, FIGS. 3 and 4 show exemplary cross-sectional views of a multi-part enclosure wall, according to further present aspects. One or more of the enclosure walls shown in FIGS. 3 and 4 can be used as the enclosure walls that can be incorporated, in turn, into the enclosures set forth in the presently disclosed apparatuses, systems, and methods.

As shown in FIGS. 3 and 4, a partial cross-sectional view of apparatuses 100, 200 (respectively) is shown. As shown in FIGS. 3 and 4, only one wall of the contemplated enclosure is shown in communication with the overall apparatus for the purpose of highlighting present aspects. It is understood that the apparatus 100 can include a plurality of walls with one or more of the walls incorporating the features of the multi-part wall configurations shown in FIGS. 3 and 4.

According to present aspects, FIG. 3 shows apparatus 100 comprising an enclosure wall 114, configured as a two-part enclosure wall and further comprising enclosure wall first section 114a (configured as an enclosure outer wall section that has one surface exposed to an enclosure exterior) and enclosure wall second section 114b (configured as an enclosure inner wall section that has one surface exposed to an enclosure interior). As further shown in FIG. 3, enclosure wall first section 114a is shown as a “fixed” wall section, and enclosure wall second section 114b is shown as a moveable wall section, with the ability to move enclosure wall second section 114b shown by being in communication with wheel assembly 117, with wheel assembly further in communication with a floor 116, or in communication with, for example, a directional track, etc. (not shown).

FIG. 3 further shows a plurality of resonator cavities 118a, with a portion of the resonator cavities integral with the enclosure wall first section 114a, and with the resonator cavities 118a bounded by the enclosure wall first section in combination with the adjoining enclosure wall second section 114b. That is, as shown in FIG. 3, the resonator cavities 118a comprise resonator cavity fixed walls 120 that comprise and otherwise coincide with recesses 115a in the enclosure wall first section 114a. The resonator cavities 118a are further bounded by enclosure wall second section projections 115b in the enclosure wall second section 114b. As shown in FIG. 3, a projection surface 115c is configured to become a resonator cavity “moveable” wall 122 when the two enclosure wall sections 114a, 114b are positioned proximate to one another. Resonator cavities 118a further each comprise a resonator neck 124, with the area within the resonator neck considered to contribute to a total area of a resonator cavity area. As shown at least in FIG. 3, resonator neck 124 provides a pathway from the resonator cavity through a thickness of a wall section to an “environment” located exterior to the wall section (and exterior to the enclosure), equivalently referred to herein as an exterior environment.

FIG. 3 further shows apparatus 100 comprising a resonator cavity actuator 126 that, as shown in FIG. 3, can be integral with resonator cavity drive mechanism 128, with the resonator cavity drive mechanism 128 in communication with: 1) the enclosure wall second section 114b; 2) the enclosure wall second section projection; and 3) the resonator cavity moveable wall 122. In a present aspect, as shown in FIG. 3, when the drive mechanism referred to herein as the resonator cavity drive mechanism 128 can be in communication with and directly move (e.g., “drive”) the enclosure wall second section and, so doing, also “drives the resonator cavity moveable wall 122.

The resonator cavity actuator 126 and resonator cavity drive mechanism 128 are shown in FIG. 3 as being in communication with a resonator controller 130 (that can be, for example, a computer controller). FIG. 3 further shows a sound detector 132 (that can be, for example, a microphone, etc.) in communication with controller 130. The controller 130 can receive signal from the sound detector 132, with the controller 130 then able to send signals to be received by the resonator cavity actuator 126, with the resonator cavity actuator 126 then initiating the resonator cavity drive mechanism 128 to laterally, (e.g., horizontally) move the enclosure wall second section 114b in relation to the enclosure wall first section 114a. The enclosure wall first section recess 115a is dimensioned to fit into and be received by the enclosure wall second section projection 115b (e.g., shown in FIG. 3 as a “male” feature dimensioned to “fit” into the enclosure wall first section recess 115a; a “female” feature closely dimensioned to receive the enclosure wall second section projection 115b).

As shown in FIG. 3, the enclosure wall first section 114a is understood to be a fixed wall section, and enclosure wall second section 114b is understood to be a “moveable” wall section. According to apparatus 100 and enclosure wall 114 (shown in FIG. 3 as an at least “two-part” enclosure wall), the motion required to alter the resonator cavity volume is generated by movement of the enclosure wall second section 114b into the enclosure wall first section and, by so doing, the enclosure wall second section projection 115b that comprises the resonator cavity moveable wall 122 is inserted into resonator cavity 118b, and alters the volume of the resonator cavity 118b.

While FIG. 3 shows the drive mechanism 128 in communication with the enclosure wall second section (e.g., the moveable wall section of the two-part enclosure wall) with the enclosure wall first section being a “fixed” wall section, present aspects further contemplate the drive mechanism 128 in communication with the enclosure wall first section (making the first section the “moveable” section, and the enclosure wall second section configured to be a fixed wall section. Still further present aspects contemplate both the first and second sections of the two-part enclosure wall both configured to be “moveable” wall sections with both “moveable” wall sections, according to this aspect, in communication with a drive mechanism

As further shown in FIG. 3, at least one of enclosure wall first section 114a and enclosure wall second section 114b can further comprise insulation 114c selected to, for example, further dampen sound, etc., with the insulation 114c selected to dampen sound, with sound-dampening characteristics of the selected insulation 114c further contributing to present sound-reducing (e.g., sound dampening) aspects of the presently presented enclosures, and according to present aspects.

FIG. 4 shows further present aspects for an enclosure apparatus for dampening sound by adjusting, tailoring, altering, etc., at least one resonator within an enclosure wall, in real-time, in response to a sound level that is detected exterior to the enclosure. According to present aspects, FIG. 4 shows apparatus 200 comprising an enclosure wall 214, configured as a multi-part enclosure wall and further comprising enclosure wall first section 214a (configured as an enclosure inner wall section that has one surface exposed to an enclosure interior) and enclosure wall second sections 214b (configured as enclosure outer wall sections that have one surface exposed to an enclosure exterior, or, an environment outside of the enclosure). As further shown in FIG. 4, enclosure wall first section 214a is shown as a “fixed” wall section, and enclosure wall second sections 214b are shown as vertically moveable wall sections relative to the enclosure wall first section 214a, with the general range of vertical direction of movement of the enclosure wall second sections 214b shown by the vertical arrows.

FIG. 4 further shows a plurality of resonator cavities 218a integrated into enclosure wall 214, with a portion of the resonator cavities 218a further integral with the enclosure wall first section 214a, and with the resonator cavities 218a bounded by the enclosure wall first section in combination with the adjoining enclosure wall second sections 214b. That is, as shown in FIG. 4, the resonator cavities 218a comprise resonator cavity fixed walls 220 that comprise and otherwise coincide with recesses 215 in the enclosure wall first section 214a. The resonator cavities 218a are further incompletely bounded by enclosure wall second sections 214b. As shown in FIG. 4, resonator cavities 218a further each comprise a resonator neck 224, with the area within the resonator neck considered to contribute to a total area of a resonator cavity area, and with the enclosure wall second sections shown in FIG. 4 as configured to form the resonator cavity neck 224.

FIG. 4 further shows apparatus 200 comprising a plurality of resonator cavity actuators 226 at least one of which, as shown in FIG. 4, can be integral with a resonator cavity drive mechanism 228. FIG. 4 shows a plurality of resonator cavity drive mechanisms 228, with at least one resonator cavity drive mechanism 228 in communication with at least one enclosure wall second section 214b. The resonator cavity actuators 226 and resonator cavity drive mechanisms 228 are shown in FIG. 4 as being in communication with a central resonator controller 230 (that can be, for example, a computer controller). FIG. 4 further shows a sound detector 232 (that can be, for example, a microphone, etc.) in communication with controller 230. The controller 230 can receive signal from the sound detector 232, with the controller 230 then able to send signals to be received by a resonator cavity actuator 226, with the resonator cavity actuator 226 then initiating the resonator cavity drive mechanism 228 to vertically move an enclosure wall second section 214b in relation to the enclosure wall first section 214a.

As shown in FIG. 4, the enclosure wall first section 214a is understood to be a fixed wall section, and enclosure wall second sections 214b are understood to be a vertically “moveable” wall sections that, when actuated and driven can alter, in real-time, the resonator cavity neck width, and commensurately alter, in real-time the resonator neck area. Since the volume of a resonator equals the combined volume of the resonator cavity and the resonator neck, according to present aspects shown at least in FIG. 4, altering the volume of a resonator neck alters the total volume of the resonator cavity.

According to apparatus 200 and enclosure wall 214 (the “multi-part” wall), the motion required to alter the resonator cavity volume is generated by vertical movement of the enclosure wall second sections 214b with respect to the enclosure wall first section 214a. FIG. 4 shows the drive mechanisms 228 in communication with the enclosure wall second sections 214b (e.g., the moveable wall sections of the multi-part) with the enclosure wall first section 214a being a “fixed” wall section. Although not shown, present aspects further contemplate a drive mechanism that can be a single drive mechanism in communication with the enclosure wall first section 214a (making the first section the “moveable” section, and the enclosure wall second sections configured to be fixed wall sections). Still further present aspects contemplate both the enclosure wall first section and at least one of the enclosure wall second sections configured to be “moveable” wall sections with both types of “moveable” wall sections, according to this aspect, in communication with drive mechanisms.

While the tunable resonator apparatuses, systems, and methods disclosed herein, can reduce tonal peak and reduce decibel sound levels, including low frequency tones, additionally, as disclosed herein, the presently disclosed enclosures and enclosure walls can be further treated or modified to include insulation (e.g., acoustic insulation, for example, honeycomb insulation, fiberglass blankets, etc.) for significantly reducing at least the mid-to-high frequency broadband noise part of the sound spectrum.

As further shown in FIG. 4, at least one of enclosure wall first section 214a and enclosure wall second section 214b can further comprise insulation 214c selected to, for example, further dampen sound, etc., with the insulation 214c selected to dampen sound, with sound-dampening characteristics of the selected insulation 214c further contributing to present sound-reducing (e.g., sound dampening) aspects of the presently presented enclosures, and according to present aspects.

In addition, although not shown in FIG. 4, enclosure wall second sections 214b can be connected, have a point of attachment, or be a unitary piece with cutouts occurring to coincide with and otherwise provide a boundary for an opening proximate to the resonator cavity neck. In this configuration, that is not shown, the entire enclosure wall second section can be driven to move vertically such that the resonator cavity neck opening can be altered, tailored, etc., in real-time and in response to a detected sound level that is exterior to the enclosure.

In addition, the actuators and drive mechanism contemplated and according to present aspects can include systems able to deliver a force required to move a structure in communication with the actuators, dive mechanisms, with the drive mechanisms understood to include mechanical, electrical, magnetic systems that further comprise hydraulic, pneumatic, pulleys, levers, or other force-delivering mechanisms, etc.

In addition to the tailorable reduction of decibel sound levels within the present enclosures in response to detected sound levels outside of the enclosure, present apparatuses, systems and methods further address the reduction of tonal peaks that can include the fundamental frequency and the attendant harmonic frequencies that can compound a sound level.

The apparatuses and systems shown in FIGS. 1, 2, 3, and 4 can incorporate tunable resonator arrays (e.g., a plurality of selectively positioned tunable resonator having tunable resonator cavities, etc.) comprising resonators at multiple and differing frequencies to further tailor, alter, and reduce sound within an enclosure in response to detected sound outside of the enclosure by addressing harmonics of sound tones. Since the harmonics in a sound wave and series of sound waves can be coherently related, adjustments to the tunable resonator cavities (e.g. the cavities acting as sound “absorbers”, “frequency neutralizers”, etc.) can electively alter and otherwise generate a change in a primary tone frequency and primary tone frequency harmonics by selectively changing and otherwise selectively altering, in real-time, the volumes of resonator cavity neck, the length and/or width of resonator cavity necks, including the alteration of cavity neck dimensions and volumes of resonator cavities that can have varying initial resonator cavity dimensions (e.g., initial resonator cavity volumes, etc.).

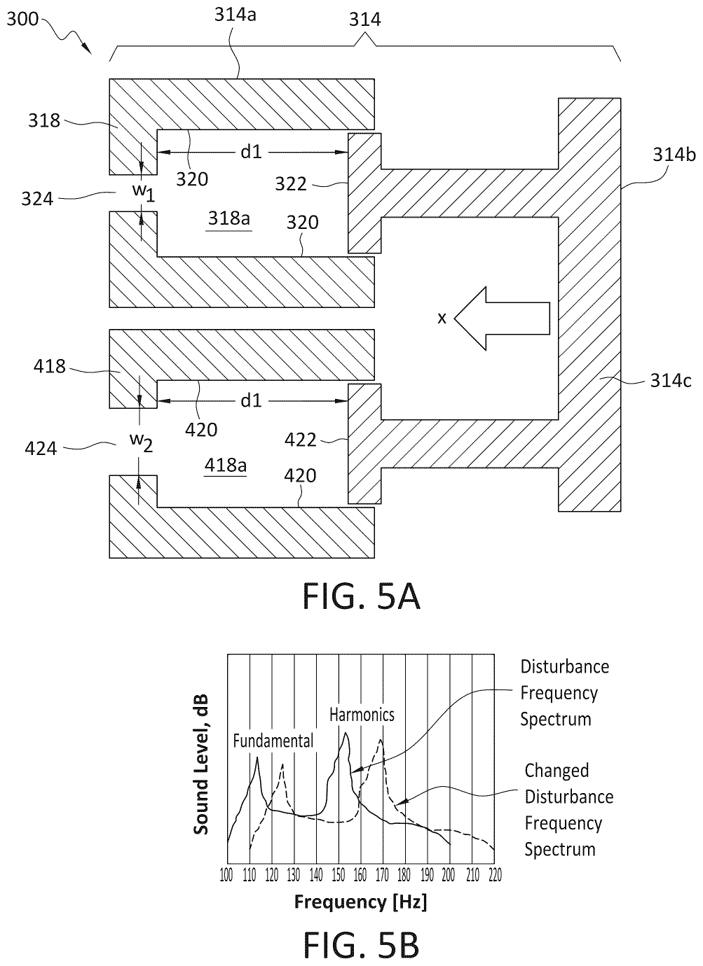

According to further present aspects, to address harmonics, two type of resonators of same size but different neck area (A2=2×A1), and differing neck widths (w1, w2) are deployed, as represented and illustrated in FIGS. 5A and 5B. As shown in the exemplary graph in FIG. 5B, an exterior (to the enclosure) sound can have an initial “fundamental” or “primary” frequency tonal peak at 100 Hz, with attendant harmonics frequency occurring at 200 HZ. According to present aspects, assuming that the resonator cavities have been tuned in response to the 100 Hz/200 Hz frequencies, and if the exterior sound increases to 110 Hz fundamental frequency and 220 Hz harmonic frequency, the detected sound increase will trigger drive mechanisms to actuate and further tune the resonator cavities to dampen both the 110 Hz/220 Hz fundamental/harmonics frequencies.

Without being bound to any particular theory, FIG. 5A illustrates an exemplary resonator orientation integral with the present enclosure walls that can achieve the substantially simultaneous dampening of both fundamental sound frequencies and the attendant harmonics. FIG. 5A, is an exemplary cross-sectional view of an enclosure wall 314 comprising an enclosure wall first section 314a that is in a “fixed” or substantially immobile orientation, and an enclosure wall second section 314b that is a moveable wall section as indicated by the arrow. Enclosure wall second section 318a further comprises resonator cavities 318a and 418a. Resonator cavity 318a is bounded by surfaces of enclosure wall first section 318a and resonator cavity moveable wall 322 that is integral with enclosure wall second section 318b (shown in FIG. 5A as a moveable wall section). Resonator cavity 418a is bounded by surfaces of enclosure wall first section 418a shown as resonator cavity wall 420 and resonator cavity moveable wall 422 that is integral with enclosure wall second section 314b (shown in FIG. 5A as a moveable wall section). Though not shown in FIG. 5A, enclosure wall second section 314b can be in communication with an actuator and drive mechanism The drive mechanism and actuator are further in communication with a computer controller that is also in communication with a sound detector. When a sound or change in sound is detected by the sound detector, and in response to the sound and/or change in sound detected by the sound detector (exterior to the enclosure), signals sent from the controller to the drive mechanism/actuator effectuate movement of the enclosure wall second section 314b and the “piston-like” resonator cavity moveable walls 322, 422 within resonator cavities 318a, 418a, respectively.

Resonator cavities 318a, 418a differ in initial area/volume, as resonator cavity neck 324 (shown as “A1”, and having a cavity neck width, “w1”) of resonator cavity 318b varies in dimension from resonator cavity neck 424 (shown as “A2”, and having a cavity neck width, “w2”) of resonator cavity 418a. As the sound level changes (e.g., increases, etc.) exterior to the enclosure housing the resonator cavity “array” (e.g., the multiple resonator cavities that, as shown in FIG. 5A, can have varying initial cavity volumes set to dampen fundamental and harmonic tonal frequencies), according to present aspects can be tuned in response to the exterior sound level increase. While being bound to no particular theory, according to Equation I from resonator equation, for resonators of the type shown, for example, in FIG. 5A:

$$f = \frac{K}{\sqrt{{d}_{1}}} \qquad ( Equation I )$$

wherein f=frequency.

if initially, f1=100 Hz and d1=2 inches, K=100\sqrt{2} for the first curve shown in FIG. 5B. Since K˜A and A is the area of the cavity neck, if everything else remains substantially constant except A, (where A2 of resonator cavity neck 324 is 2× larger than A1 of resonator cavity neck 424, the frequency for the resonator cavity 418b would be f2=200 Hz.

If the disturbance frequencies are initially 100 Hz and 200 Hz, the resonator cavities 318a, 418a reduce both of the tonal peak amplitudes of the fundamental and harmonic frequencies.

If the disturbance frequencies of the fundamental and the harmonics change, for example as shown in FIG. 5B, to 110 Hz and 220 Hz, respectively, according to present aspects, the controller will send a signal to the drive mechanism/actuator to effect a resonator cavity volume reduction by reducing, for example, d1 from an original or starting value of 2 inches to 1.65 inches by moving the wall 0.35 inches. This resonator cavity volume reduction will change accordingly, where

$${f}_{1} = \frac{100 \sqrt{2}}{\sqrt{1.65}} = 110 Hz ; and {f}_{2} = \frac{200 \sqrt{2}}{\sqrt{1.65}} = 220 Hz .$$

### Example 1

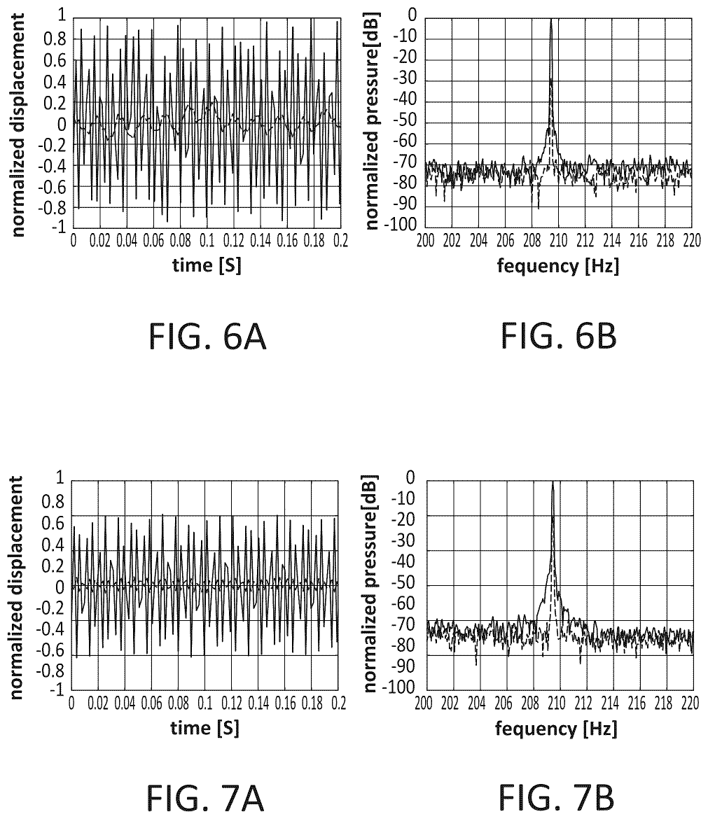

The sound reducing capabilities of present apparatuses, systems, and methods were concept was proven in laboratory testing. Reactive tuned sound absorbers acting as tunable resonator cavities were placed in a large, enclosed wooden box and a discrete frequency sound was presented to and received by interior areas with the box, with the sound originating from a loudspeaker oriented outside of the box. The sound spectrum outside and inside the box was recorded using a spectrum analyzer. The initial/untreated sound tonal peaks of the sound level within the box before present resonator tailoring is shown in FIG. 6A. When the resonators were tailored to “match” sound source frequency with the sound absorber frequency, a ˜30 decibel (dB) reduction in tone levels was obtained, as shown in FIG. 6B.

### Example 2

The experimental design set forth in Example 1 was modified such that the enclosed box was replaced with a box featuring one open wall (e.g., a partial enclosure). Reactive tuned sound absorbers acting as tunable resonator cavities were placed in the partially enclosed box featuring one open wall and a discrete frequency sound was presented to and received by interior areas with the partially enclosed box, with the sound originating from a loudspeaker oriented outside of the partially enclosed box. The sound spectrum outside and inside the partially enclosed box was recorded using a spectrum analyzer. The initial/untreated sound tonal peaks of the sound level within the partially enclosed box before present resonator tailoring is shown in FIG. 7A. When the resonators were tailored to “match” sound source frequency with the sound absorber frequency, a ˜20 decibel (Db) reduction in tone levels was obtained, as shown in FIG. 7B.

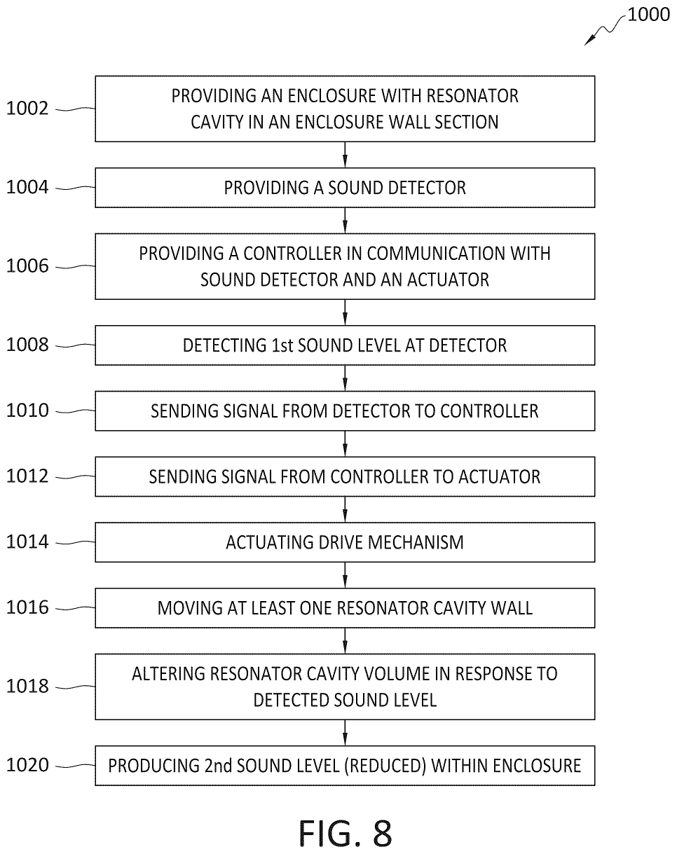

FIGS. 8, 9, 10, and 11 are flowcharts outlining methods according to present aspects, and methods that incorporate the presently disclosed systems and apparatuses. FIG. 8 outlines a method for reducing the decibel sound level within an enclosure, according to present aspects, and with the method 1000 including providing 1002 an enclosure, and with the enclosure comprising a plurality of enclosure wall sections, with at least one of the plurality of wall sections further comprising at least one resonator cavity. The at least one resonator cavity can include a first resonator cavity volume, with the at least one resonator cavity in communication with an actuator, and with the actuator further in communication with a drive mechanism. The at least one resonator cavity further includes at least one resonator cavity fixed wall, and at least one resonator cavity moveable wall, with the at least one resonator cavity moveable wall in communication with the actuator and the drive mechanism. The resonator cavity further includes a resonator cavity neck. The method 1000 further includes providing 1004 a sound detector, with at least a portion of the sound detector exposed to an area that is exterior to the enclosure, with the sound detector configured to detect a first sound level exterior to the enclosure, and with the first sound level having a first decibel value. The sound detector can be positioned exterior to the enclosure or can be integrated within the disclosure. The method 1000 further includes providing 1006 a controller, with the controller in communication with the sound detector, and with the controller further in communication with the at least one resonator cavity moveable wall.

The method 1000 further includes detecting 1008 the first sound level, with the first sound level detected exterior to the enclosure, sending 1010 a signal from the sound detector to the controller, sending 1012 a signal from the controller to the actuator, actuating 1014 the drive mechanism, and moving 1016 the at least one resonator cavity moveable wall. The method 1000 further includes altering 1018 the first resonator cavity volume to a second resonator cavity volume in response to the first sound level detected exterior to the enclosure, and producing 1020 a second sound level within the enclosure, with the second sound level having a second decibel value, and with the second decibel value less than the first decibel value.

In another aspect, the second decibel value represents a reduction in decibel value from the first or initial, decibel value by an amount ranging from about a 20 to about a 25 decibel reduction. The method 1000 can incorporate the apparatuses and systems shown at least in FIGS. 1, 2, 3, 4 and 5; and can produce decibel sound reductions and sound peak alterations within an enclosure on the order of the sound decibel reductions and peak alterations shown in FIGS. 6B and 7B.

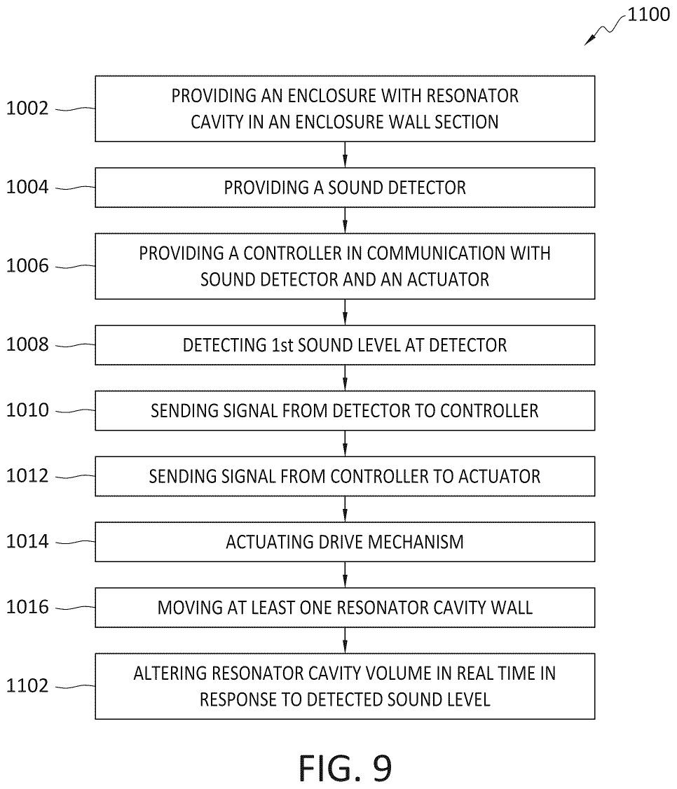

FIG. 9 is a flowchart outlining a method 1100 for reducing the decibel sound level within an enclosure, according to present aspects, and similar to the method 1000 outlined in FIG. 8, (and including the steps of method 1000). Method 1100 includes the steps of method 1000 shown in FIG. 8, and further comprises, in step 1102, altering the first resonator cavity volume to a second resonator cavity volume in response to the first sound level detected exterior to the enclosure can be conducted in real-time. The method 1100 can incorporate the apparatuses and systems shown at least in FIGS. 1, 2, 3, 4, and; 5; and can produce decibel sound reductions and sound peak alterations within an enclosure on the order of the sound decibel reductions and peak alterations shown in FIGS. 6B and 7B.

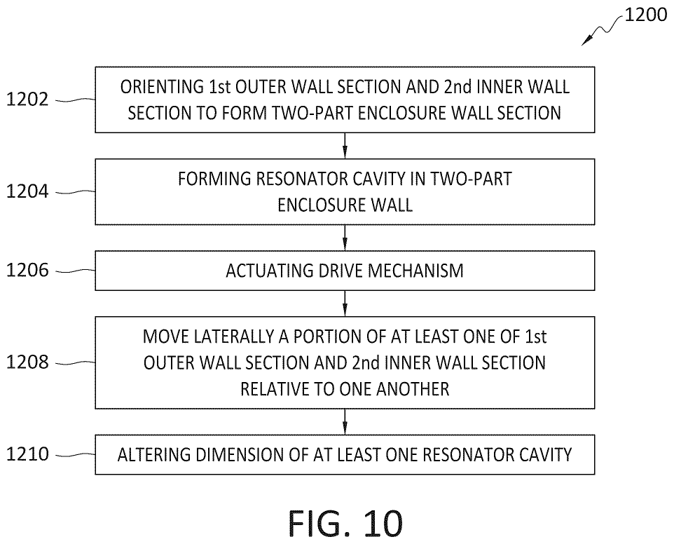

FIG. 10 is a flowchart outlining a method for reducing the decibel sound level within an enclosure, according to present aspects, and with the method 1200 including orienting 1202 an enclosure wall first section and an enclosure wall second section relative to one another to form an at least two-part enclosure wall section, and forming 1204 at least one resonator cavity in the at least two-part enclosure wall section, with the said at least one resonator cavity oriented between the enclosure wall first section and the enclosure wall second section. Method 1200 further comprises actuating 1206 the drive mechanism, moving laterally 1208 at least a portion of at least one of the enclosure wall first section and the enclosure wall second section relative to one another, and altering 1210 the dimension of the at least one resonator cavity. The method 1200 can incorporate the apparatuses and systems shown at least in FIGS. 1, 2, and 3; and can produce decibel sound reductions and sound peak alterations within an enclosure on the order of the sound decibel reductions and peak alterations shown in FIGS. 6B and 7B.

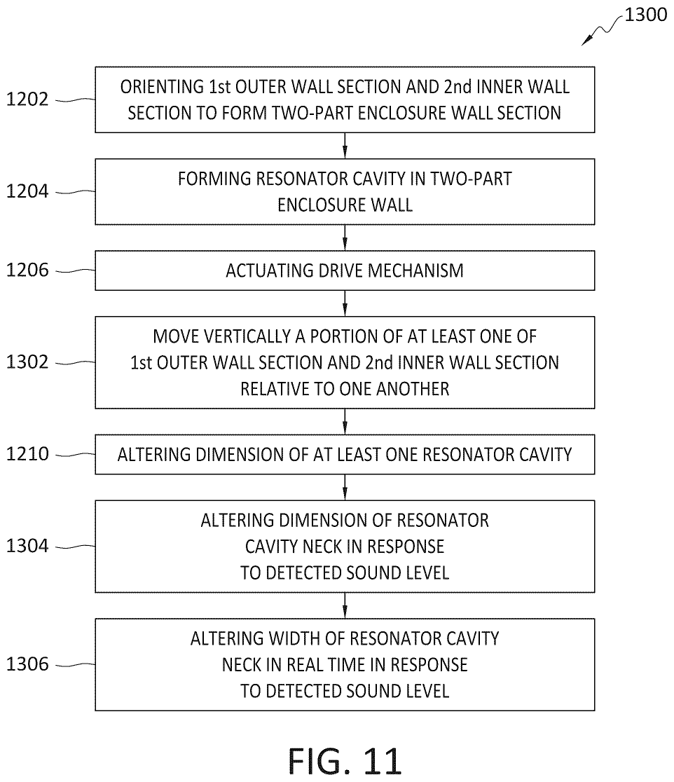

FIG. 11 is a flowchart outlining a method for reducing the decibel sound level within an enclosure, according to present aspects, and with the method 1300 including orienting 1202 an enclosure wall first section and an enclosure wall second section relative to one another to form an at least two-part enclosure wall section, and forming 1204 at least one resonator cavity in the at least two-part enclosure wall section, with the said at least one resonator cavity oriented between the enclosure wall first section and the enclosure wall second section. Method 1200 further comprises actuating 1206 the drive mechanism and moving vertically 1302 at least one of the enclosure wall first section and the enclosure wall second section relative to one another and altering 1210 the dimension of the at least one resonator cavity. Method 1300 further comprises altering 1304 the dimension of the at least one resonator cavity neck, for example, in response to a detected sound level exterior to the enclosure, with method 1300 further comprising altering 1306 the dimension of the at least one resonator cavity neck in real-time. The method 1300 can incorporate the apparatuses and systems shown at least in FIG. 4, and can produce decibel sound reductions and sound peak alterations within an enclosure on the order of the sound decibel reductions and peak alterations shown in FIGS. 6B and 7B.

According to present aspects, the terms “in real-time” and “substantially in real-time” are used equivalently, with “real-time” (as used herein) referring to a duration of time measured from the time a sound level is detected to the initiation of an alteration of the resonator cavity, and occurring in an elapsed time ranging from about 0.1 to 0.5 seconds, although faster elapsed times are contemplated.

The present aspects may, of course, be carried out in other ways than those specifically set forth herein without departing from essential characteristics of the disclosure. The present aspects are to be considered in all respects as illustrative and not restrictive, and all changes coming within the meaning and equivalency range of the appended claims are intended to be embraced therein.

What is claimed is:

1. An enclosure wall for a habitable enclosure, the enclosure wall comprising:
an enclosure wall interior thickness;
at least one resonator cavity oriented within the enclosure wall interior thickness, said at least one resonator cavity comprising:
a resonator cavity fixed wall;
a resonator cavity movable wall,
a resonator cavity first volume,
a resonator cavity neck, said resonator cavity neck comprising a first resonator cavity neck width;
a sound detector, said sound detector configured to detect a first sound decibel level exterior to the habitable enclosure;
a controller, said controller in communication with the sound detector, said controller further in communication with the resonator cavity moveable wall;
wherein said resonator cavity movable wall is in communication with a drive mechanism, said drive mechanism configured to move the resonator cavity movable wall; and
wherein said enclosure wall is configured to be incorporated into the habitable enclosure, said habitable enclosure defining a habitable enclosure area.

2. The enclosure wall of claim 1, wherein said drive mechanism is in direct communication with the resonator cavity movable wall, said drive mechanisms configured to drive vertically in real time the resonator cavity moveable wall to alter the resonator cavity first volume to a resonator cavity second volume in response to the first sound level.

3. The enclosure wall of claim 1, wherein said enclosure wall comprises a two-part enclosure wall, said two-part enclosure wall comprising:
an enclosure wall first section;
an enclosure wall second section;
wherein at least one of the enclosure wall first section and the enclosure wall second section comprises a moveable enclosure wall section, said movable enclosure wall section further comprising the resonator cavity movable wall, said movable enclosure wall section in direct communication with the drive mechanism; and
wherein the enclosure wall first section and the enclosure wall second section in combination form the two-part enclosure wall.

4. The enclosure wall of claim 3, wherein at least one of the enclosure wall first section and the enclosure second wall section is a fixed wall section.

5. The enclosure wall of claim 3, wherein said drive mechanism is further configured to move at least one of the enclosure wall first section and the enclosure wall second section laterally relative to one another.

6. The enclosure wall of claim 3, wherein the two-part enclosure wall is configured to form the at least one resonator cavity within the two-part enclosure wall, and
wherein the at least one of the enclosure wall first section and the enclosure wall second section is configured to move laterally relative to one another to alter the resonator cavity first volume to a resonator cavity second volume, said resonator cavity second volume differing from the resonator cavity first volume.

7. The enclosure wall of claim 3, wherein the movable enclosure wall section comprises the resonator cavity movable wall.

8. The enclosure wall of claim 3, wherein the enclosure wall first section comprises a plurality of moveable enclosure wall sections, each of said plurality of moveable enclosure wall sections in communication with a separate drive mechanism.

9. The enclosure wall of claim 8, wherein at least one of the plurality of moveable enclosure wall sections is configured to move vertically relative to the enclosure wall second section to alter the first resonator cavity neck width to a second resonator cavity neck width in response to a detected first sound level.

10. The enclosure wall of claim 9, wherein at least one of the plurality of moveable enclosure wall sections is configured to move vertically relative to the enclosure wall second section to alter the resonator cavity first volume to a resonator cavity second volume in response to a detected first sound level.

11. The enclosure wall of claim 1, wherein the drive mechanism is configured to drive in real-time the resonator cavity moveable wall to alter the resonator cavity first volume of the at least one resonator cavity in response to a detected first sound level.

12. The enclosure wall of claim 1, wherein the drive mechanism is configured to drive in real-time the resonator cavity moveable wall laterally to alter the resonator cavity first volume of the at least one resonator cavity in response to a detected first sound level.

13. The enclosure wall of claim 1, wherein the drive mechanism is configured to drive in real-time the resonator cavity moveable wall vertically to alter the resonator cavity first volume of the at least one resonator cavity in response to a detected first sound level.

14. A habitable enclosure comprising the enclosure wall of claim 3.

15. A habitable enclosure comprising the enclosure wall of claim 9.

16. A habitable enclosure comprising:
an enclosure wall, the enclosure wall comprising:
an enclosure wall interior thickness;
at least one resonator cavity oriented within the enclosure wall interior thickness, said at least one resonator cavity comprising:
a resonator cavity fixed wall;
a resonator cavity movable wall,
a resonator cavity first volume,
a resonator cavity neck, said resonator cavity neck comprising a first resonator cavity neck width;
a sound detector, said sound detector configured to detect a first sound decibel level exterior to the habitable enclosure;
a controller, said controller in communication with the sound detector, said controller further in communication with the resonator cavity moveable wall;
wherein said resonator cavity movable wall is in communication with a drive mechanism, said drive mechanism configured to move the resonator cavity movable wall; and
wherein said habitable enclosure defines a habitable enclosure area.

17. A method for altering a decibel level of sound within a habitable enclosure, the method comprising:
providing a habitable enclosure, said habitable enclosure comprising a habitable enclosure area, said habitable enclosure further comprising:
a plurality of enclosure walls, said plurality of enclosure walls in direct communication with each other, said plurality of enclosure walls further in direct communication with a floor, at least one of the plurality of enclosure walls further comprising at least one resonator cavity, said at least one resonator cavity comprising:
a resonator cavity fixed wall;
a resonator cavity movable wall, said resonator cavity movable wall in communication with a drive mechanism configured to move the resonator cavity movable wall,
a resonator cavity first volume,
a resonator cavity neck, said resonator cavity neck comprising a first resonator cavity neck width;
providing a sound detector, said sound detector positioned exterior to the habitable enclosure, said sound detector configured to detect a first sound level exterior to the enclosure, said first sound level having a first decibel value;
providing a controller, said controller in communication with the sound detector, said controller further in communication with the drive mechanism;
detecting with the sound detector the first sound level, said first sound level detected exterior to the enclosure;
sending a signal from the sound detector to the controller;
sending a signal from the controller to the drive mechanism;
actuating the drive mechanism;
moving the at least one resonator cavity moveable wall;
altering the resonator cavity first volume to a resonator cavity second volume in response to the first sound level detected exterior to the habitable enclosure by the sound detector;
altering the decibel level of sound within the habitable enclosure; and
producing a second sound level within the habitable enclosure, said second sound level having a second decibel value, said second decibel value less than the first decibel value.

18. The method of claim 17, wherein the second sound level represents a reduction in decibel value from the first decibel value by a decibel value ranging from about 20 to about 25 decibels.

19. The method of claim 17, wherein at least one of the plurality of enclosure walls comprises a two-part enclosure wall, said two-part enclosure wall comprising:
a two-part enclosure wall first section;
a two-part enclosure wall second section;
wherein one of the two-part enclosure wall first section and the two-part enclosure wall second section is a fixed wall section;
wherein at least one of the two-part enclosure wall first section and the two-part enclosure wall second section comprises a two-part enclosure wall moveable wall section, said two-part enclosure wall moveable wall section in communication with the drive mechanism;
forming the at least one resonator cavity within the at least two-part enclosure wall, said at least one resonator cavity oriented between the two-part enclosure wall first section and the two-part enclosure wall second section; and
moving laterally at least a portion one of the two-part enclosure wall first section and the two-part enclosure wall second section relative to one another in response to detecting with the sound detector the first sound level.

20. The method of claim 19, wherein the two-part enclosure wall comprises a plurality of two-part enclosure wall moveable wall sections, each of said plurality of two-part enclosure wall moveable wall sections in communication with a separate drive mechanism.
